(19) United States
(12) Patent Application Publication
(10) Pub. No.: US 2002/0048504 A1
(43) Pub. Date: Apr. 25, 2002

(54) ATV mechanical lift

(76) Inventor: Ottis Earl Jacobs, Ralph, AL (US)

Correspondence Address: Ottis E Jacobs, Sr., 17621 Highway 11 South, Ralph, AL, 35480, US

(21) Appl. No.: 09/946,084

(22) Filed: Sep. 4, 2001

Related U.S. Application Data
(60) Provisional application No. 60/231,196, filed on Sep. 7, 2000.

(51) Int. Cl. B60P 1/00

(52) U.S. Cl. 414/541; 414/543; 414/462

(57) ABSTRACT

An assist mechanism for loading and unloading irregularly shaped cargo, such as for example, bags of stock feed or dead wild game (e.g. boars or deer), includes a support assembly, a boom assembly, a frame assembly, and a winch assembly. The boom assembly is movable along three axes to facilitate loading and unloading of said cargo. The support assembly is attached to the front of the vehicle using the frame assembly and associated hardware. The winch assembly includes a winch, rope and hook and is attached to the support assembly and integrated onto the boom assembly for maneuvering cargo.

### BACKGROUND OF THE INVENTION

This invention relates to an assist mechanism to facilitate the loading and unloading of cargo onto vehicles, and in particular for lifting irregularly shaped cargo items onto an full-sized All-Terrain Vehicle (ATV).

Personnel who choose to use their ATV's to transfer heavy cargo typically must use personal brute force or seek assistance to load cargo in excess of their normal capabilities. In addition, at times, there may be no assistance available as ATV's are designed to be operated by a solo person. Therefore, if the load is very heavy or irregular in shape compared to the abilities of the operator to lift, a method of assisting the loading of the heavy object is required to successfully accomplish the task in a safe manner.

ATV operators often have to bend over to lift or move the irregular shaped cargo. This action generally puts a lot of stress on the musculoskeletal system of the body and can lead to injury, especially to the back, shoulders, and wrists of the operator.

Conventional hydraulic lifts used for loading or unloading heavy loads onto cargo trucks or vans using mechanical lifts such as lift gates, are often very costly, bulky, and not well adapted for attachment to a one person vehicle of a size and nature similar to the ATV. These lifts generally move in only one direction, typically vertically, and require the operator to still maneuver the load horizontally onto the vehicle after the vertical traverse has completed its path of travel.

There are no known viable options other than the aforementioned brute force or assisted techniques available to the ATV operator who desires to load and transport cargo heavier than their normal capabilities in a complete manner.

Accordingly, there is a need for a loading assistance system for ATV operators needing to transport heavy or irregularly shaped cargo causing lifting burdens, greater than their normal capabilities, solving the aforementioned problems.

Several objects and advantages of the present invention are:

(a) to be easily attached to and/or removed from existing full-sized 4-wheel ATV models known to be available in the market today

(b) allows for the almost effortless loading of heavy or irregularly shaped loads weighing up to approximately 200 pounds by a single operator

(c) allows for the full vertical as well as horizontal traverse of the cargo in an assisted manner. Facilitating the complete loading or unloading of the cargo in a mechanical-assist manner.

(d) does not detract from the normal intended operation of a stock ATV after installation.

### BRIEF DESCRIPTION OF THE SEVERAL VIEWS OF THE DRAWING

FIG. 1 is a side view embodiment of the present invention

FIG. 2 is a side view embodiment of the invention as intended to be attached to an ATV (simulated without detail)

FIG. 3A and 3B are an exploded view of the present invention including illustrated mounting hardware

Reference Numerals in Drawings

| | |
|---|---|
| 100 - ATV (simulated without detail) | 99 - Cargo (simulated) |
| 101 - Support Assembly | 201 - Boom Assembly |
| 301 - Frame Assembly | 401 - Winch Assembly |
| 1 - Support Tube | 12 - Metal Extension |
| 2A - Support Pin | 13 - Rope |
| 2B - Anchor Pin | 14 - Angle Tube |
| 3 - ATV Interface | 15 - Extension Holder |
| 4. - Extension Rod | 16 - Bolt |
| 5 - Winch | 17 - Nut |
| 6 - Anchor | 18 - Alignment Bracket |
| 7 - Nut | 19 - Winch Bracket |
| 8 - Bolt | 20 - Nut |
| 9 - Swivel Pulley | 21A,B,C,D - Pin Holes |
| 10 - Metal Ring | 22 - Support Bar A |
| 11 - Hook | 23 - Angle Bracket |
| | 24 - Rotator Collar |

### DETAILED DESCRIPTION OF THE INVENTION

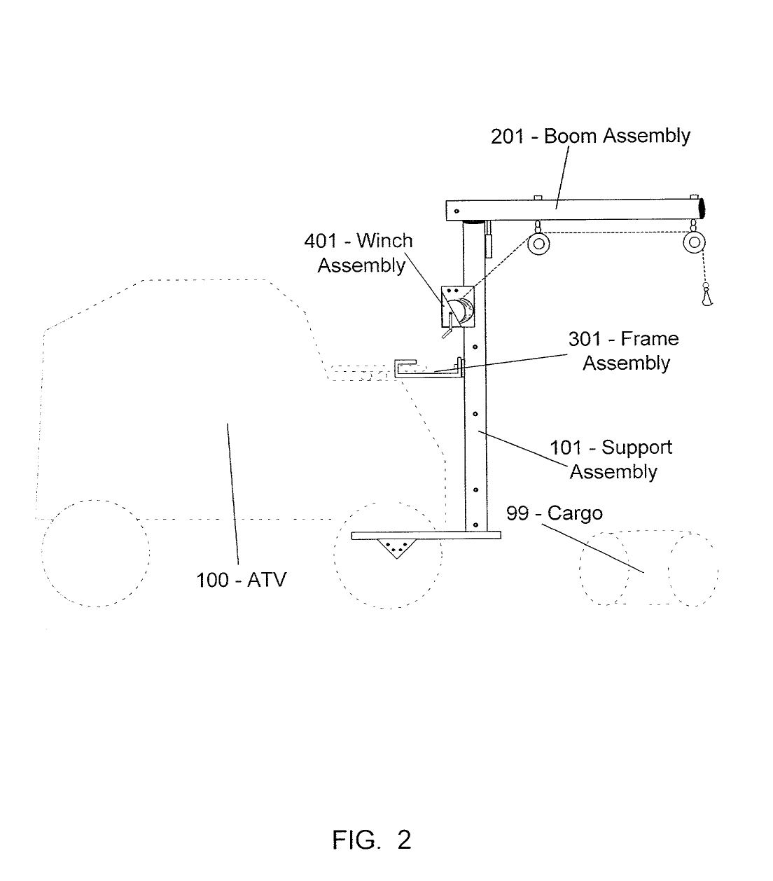

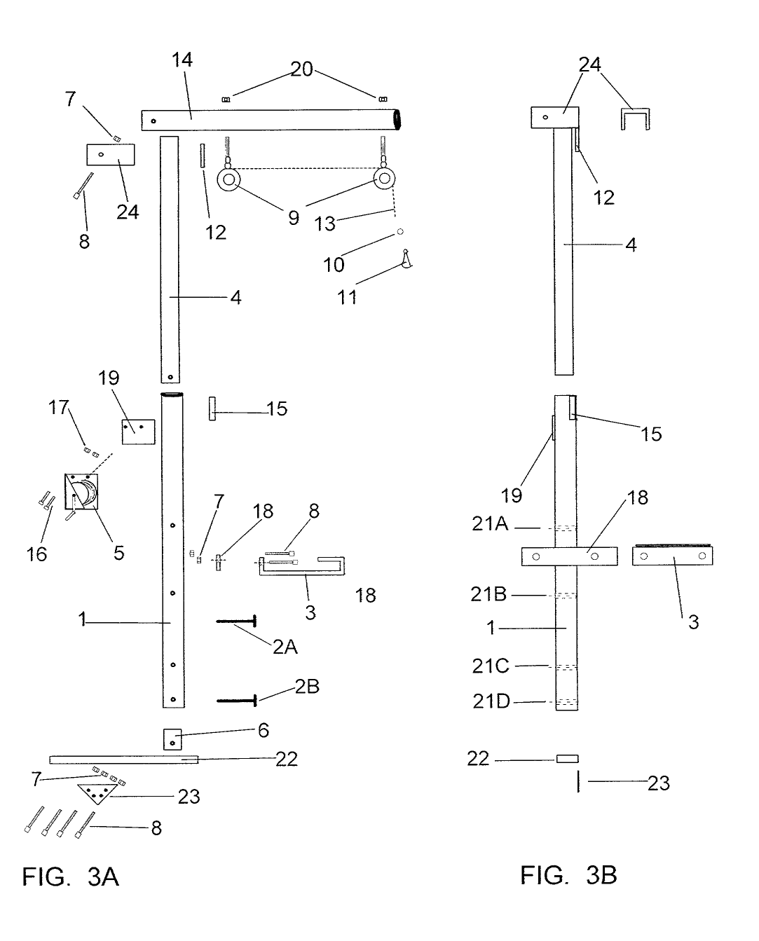

Referring now to the drawings, in which like reference numerals illustrate similar or identical elements, there is shown the lift assist mechanism disclosed herein. Referring to FIGS. 2 and 3, the lift mechanism and operation are illustrated. To load the Cargo (99) onto an ATV (100), the ATV (100) is stopped within a few feet of the Cargo (99) with the Boom Assembly (201) in a direct line of sight to the Cargo (99). By pulling the Support Pin (2A) from the lower Pin Hole (21C) in the Support Tube (1) and then elevating the Boom Assembly (201) vertically by hand until the bottom of the Extension Rod (4) clears either Pin Hole (21A or 21B) then reinserting Support Pin (2A). This action separates the Metal Extension (12) safety lock from the Extension Holder (15) and thus allows the Boom Assembly (201) to rotate horizontally freely. Using a pulling action by hand on Rope (13), the Rope (13) is extended until sufficient length is exposed from the distal end of the Boom Assembly (201) to allow the Hook (11) end of the Rope (13) to be draped around the Cargo (99) circumference then secured to Rope (13) by operating the spring level mechanism on Hook (11). The handle on Winch (5) is then rotated in a clock-wise fashion which retracts the Rope (13) and thus elevates the Cargo (99) in a line toward Swivel Pulley (9) on the end of Boom Assembly (201). Once the Cargo (99) has elevated sufficient distance, the Cargo (99) can be rotated horizontally until it resides directly over the ATV (100). By reversing the direction of movement to counterclockwise for the handle on Winch (5), the Cargo (99) can be lowered onto the ATV (100) and secured in place for travel using a lock on Winch (5) and the Rope (13).

A typical embodiment of the invention is illustrated in FIGS. 2 & 3. The ATV Mechanical Lift has a Boom Assembly (201), a Support Assembly (101), a Frame Assembly (301) and a Winch Assembly (401). The Boom Assembly (201) contains an Angle Tube (14). a Rotator Collar (24), two each Swivel Pulley (9), an Extension Rod (4) and Metal Extension (12). The Support Assembly (101) is a weight carrying structure consisting of a Support Tube (1), an ATV interface attachment Alignment Bracket (18), an Extension Holder (15), an Anchor (6), ATV base attachment items Support Bar A (22), an Angle Bracket (23), a Winch Bracket (19) and associated mounting hardware. The Frame Assembly (301) includes the ATV Interface (3) and associated mounting hardware for securing the Support Assembly (101) to the ATV (100). The Winch Assembly (401) includes the Winch (5), a Rope (13), a Metal Ring (10) and a Metal Hook (11) and associated mounting hardware.

The basic structure consists of the Support Assembly (101), Boom Assembly (201), and the Frame Assembly (301) which are all made of rolled or tubular steel or similar metal alloys to provide the basic operational support structure. The operational elements in addition to the structure aforementioned are: the Winch (5) to extend and/or retract the Rope (13) and the attached Metal Ring (10) and attached Hook (11) to secure the cargo during loading, and the Rotator Collar (24) which allows the Angle Tube (14) to pivot in one plane with respect to the Pin (8) inserted into the Rotator Collar (24) welded onto the top of Extension Tube (4) and mechanically attached to the proximal end of Angle Tube (14).

FIG. 3A is an exploded view that details all typical mounting hardware to be used. FIG 3A is a side view and FIG. 3B is a front view of several components. Key components: the ATV Interface (3) is used to keep the Support Assembly (101) aligned with the ATV cargo rack; the Metal Extension (12) is placed into the Extension Holder (5) when the Extension Rod (4) is lowered to secure it from rotating; the Anchor (6) is welded to Support Bar A (22) and the Support Tube (1) is placed over it, then Anchor Pin (2B) is placed into the hole to secure the Support Tube (1); Bar A (22) is intended to be mechanically attached to the frame of the ATV (100) by metallic welding or, in a temporary manner, using U-Bolts or a similar mechanical attachment method, Bar B (23) is then attached to Support Bar A (22) using Bolts (8) and Nuts (7). Thereby securing the system to the ATV (100).

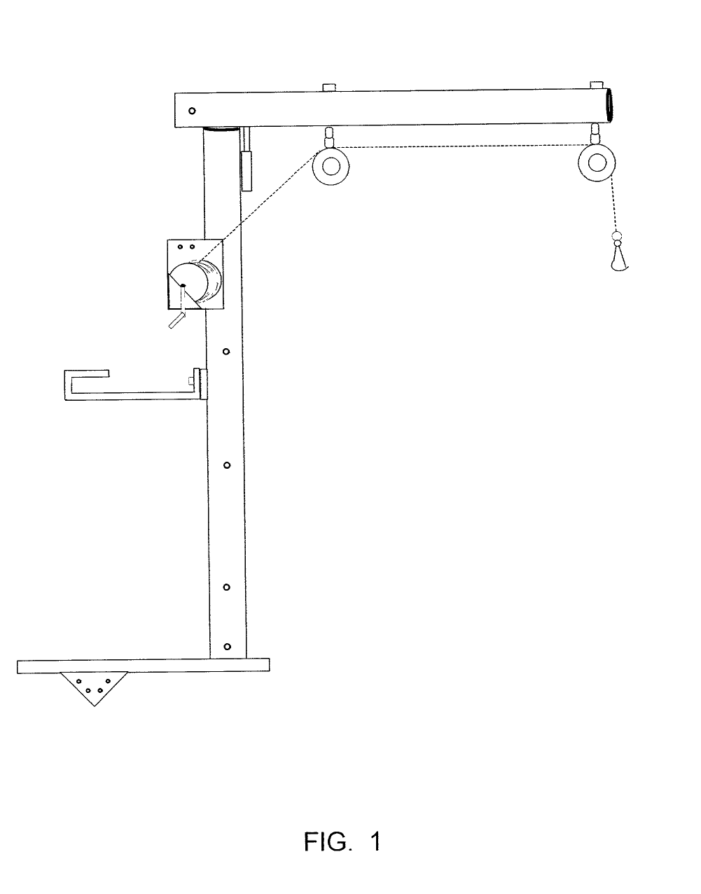

Operation—FIG. 1

The manner of using the present invention is detailed as follows. The Extension Rod (4) is manually raised after removing the Pin (2A) which was inserted for secure travel into Pin Hole (21C) in the Support Tube (1). This action will disengage the Metal Extension (12) from the Extension Holder (15) and allow the Boom Assembly (201) to freely rotate over to the Cargo (99) to be loaded. The ATV operator should then manually raise the Extension Rod (4) to the desired height and reinsert Support Pin (2A) into Pin Holes (21A or 21B) as appropriate to support the Extension Rod (4) in the Support Tube (1). The operator should extend the Rope (13) by pulling on Hook (11), securely attach the Rope (13) to the Cargo (99) using the Hook (11) in any manner they consider appropriate. Subsequently, using the Winch (5), the operator may elevate the Cargo (99) and then horizontally rotate the Angle Tube (14) and the Cargo (99) around in the horizontal direction and align the Cargo (99) with the top of the ATV (100) for transport.

The multiple adjustment Pin Holes (21A/B/C) FIGS. 2 and 3 allow for the ATV operator to adjust the height of the Extension Rod (4) up for use in loading cargo or down for lowering in storage or for safe travel. The Rotator Collar (24) allows the Angle Tube (14) to rotate in the vertical plane ranging from near horizontal, when in the resting or down position, to approximately 145 to 180 degrees counterclockwise.

Conclusions, Ramifications, and Scope

Accordingly, the reader will see that the present invention can be easily attached to a typical full-sized ATV, without major modifications or excess added weight. The system is easy to use and does not detract from the enjoyment or safe operation of the ATV.

The invention provides an ability for a solo operator to load cargo beyond their individual capabilities without assistance.

The scope of the invention should be determined by the appended claims when filed and their legal equivalents, rather than any examples given.

I claim:

1. A device for loading and unloading cargo onto and off of an All-Terrain Vehicle (ATV), comprising: a support assembly adapted to be mounted to an ATV using a frame assembly; a boom assembly adapted to operatively traverse the load in the horizontal plane while attached to the aforementioned support assembly; a winch assembly with a manually operated mechanical winch attached to the support assembly and integrated with the boom assembly adapted to facilitate the loading and unloading of the cargo.

2. A method for loading cargo onto an All-Terrain Vehicle (ATV), comprising the steps of: securing the lift assembly to the ATV, the lift assembly including a support assembly adapted to be mounted to the front of an ATV using a frame assembly; a boom assembly adapted to operatively traverse the load in the horizontal plane while attached to the aforementioned support assembly; a winch assembly with manual mechanical winch attached to the support assembly and integrated with the boom assembly adapted to facilitate the loading and unloading of the cargo; securing the cargo using the attached rope and hook of the winch assembly; lifting the cargo along the first axis by manually operating the winch; rotating the cargo in the second axis by pulling or pushing on the boom assembly as appropriate; and lowering the cargo onto the ATV in the first axis by reversing the direction of travel of the winch.

3. A method according to claim 2, wherein at least the lifting step is performed under automatic power.
